(19) United States
(12) Patent Application Publication
(10) Pub. No.: US 2023/0320277 A1
(43) Pub. Date: Oct. 12, 2023

(54) SYSTEMS AND METHODS FOR DRYING PLANT MATERIAL USING MOLECULAR SIEVES

(71) Applicant: OPCIP-HOLDCO, LLC, Huron, OH (US)

(72) Inventors: Stephen David Wobser, Sandusky, OH (US); Raymond George Troyer, Sandusky, OH (US)

(73) Assignee: OPCIP-HOLDCO, LLC, Huron, OH (US)

(21) Appl. No.: 18/299,001

(22) Filed: Apr. 11, 2023

Related U.S. Application Data
(60) Provisional application No. 63/329,861, filed on Apr. 11, 2022.

(51) Int. Cl. A01F 25/12; F26B 7/00

(52) U.S. Cl. CPC A01F 25/12; F26B 7/005; F26B 2200/02

(57) ABSTRACT

Systems and methods are provided for drying plant material using molecular sieves.

### CROSS-REFERENCE TO RELATED APPLICATIONS

This application claims priority from U.S. Provisional Patent Application No. 63/329,861, filed on Apr. 11, 2022, which is incorporated by reference herein in its entirety.

### BACKGROUND

When drying plant material, such as drying harvested plants, significant quantities of water must be removed from the harvested plant to make the plant product suitable for storage and/or consumption.

Some plants, such as cannabis, include terpenes that are very desirable to retain in the harvested plant during the drying process. The terpenes are a highly valued component of cannabis flower and processed cannabis products. The smell of cannabis, the distinction between cultivars, and the medical and recreational effects are all attributed in part to the terpene profile (the relative quantities of terpene and terpenoid molecules in each plant or product). Thus, it is desirable to maintain the full terpene profile throughout manufacturing processes so that the smell, flavor, and effects of the original cannabis plant are well represented in downstream products (e.g., dried flower and processed cannabis products).

Traditionally, cannabis flower is dried by hanging or racking the harvested cannabis in open air or within a temperature-controlled and humidity-controlled room. When drying hash, it is common to use freeze drying (e.g., lyophilization). However, these drying techniques, while efficiently removing water, undesirably remove terpenes via evaporation. The evaporated terpenes are vented from the system or deposited upon a condenser or other cool surface, but in any event are lost from the dried plant. Additionally, some specific terpenes are lost more quickly than others, resulting in a post-drying ratio of terpenes that is potentially very different from the terpene ratios found in the pre-drying cannabis plant. As a result, the terpene profile of the dried plant may be altered and/or diminished relative to the original plant. This post-drying terpene profile may be detrimental to the smell, distinction between cultivars, and the medical and recreational effects of the original plant.

What is needed is a drying process that retains the volatile terpenes and the terpene profile throughout the drying process.

### SUMMARY

In one aspect, a system for drying a plant material is provided, the system comprising: an airtight container containing: the plant material, a plurality of molecular sieves, optionally a gas, and optionally a circulation device.

In another aspect, a system for drying a plant material is provided, the system comprising: an airtight plant material container containing the plant material; an airtight circulation device container containing a circulation device; a sieve chamber containing a plurality of molecular sieves; an outlet duct extending from the circulation device through a wall of the plant material container; a sieve chamber inlet duct extending through a wall of the plant material container to a proximal (upstream) end of the sieve chamber; and a sieve chamber outlet duct extending from a distal (downstream) end of the sieve chamber through a wall of the circulation device container.

In another aspect, a method for drying a plant material is provided, the method comprising: providing an airtight container containing: the plant material, a plurality of molecular sieves, a gas, and a circulation device; circulating the gas within the container causing the gas to contact the plant material and the plurality of molecular sieves, wherein water within the plant material turns to water vapor and flows with the gas, wherein the water vapor contacts the molecular sieves, and wherein the molecular sieves adsorb the water vapor.

In another aspect, a method for drying a plant material is provided, the method comprising: providing: an airtight plant material container containing the plant material, an airtight circulation device container containing a circulation device and a gas, a sieve chamber containing a plurality of molecular sieves, an outlet duct extending from the circulation device through a wall of the plant material container; a sieve chamber inlet duct extending through a wall of the plant material container to a proximal (upstream) end of the sieve chamber, and a sieve chamber outlet duct extending from a distal (downstream) end of the sieve chamber through a wall of the circulation device container; circulating the gas from the circulation device, through the outlet duct, through the plant material container, through the sieve chamber inlet duct, through the sieve chamber, through the sieve chamber outlet duct, to the circulation device container, and back into the circulation device; wherein circulating the gas causes the gas to contact the plant material and the plurality of molecular sieves, wherein water within the plant material turns to water vapor and flows with the gas, wherein the water vapor contacts the molecular sieves, and wherein the molecular sieves adsorb the water vapor.

In another aspect, a method for drying a plant material is provided, the method comprising: providing: an airtight plant material container containing: the plant material, a circulation device, and a gas, a sieve chamber containing a plurality of molecular sieves, an outlet duct, a sieve chamber inlet duct extending through a wall of the plant material container to a proximal (upstream) end of the sieve chamber, and a sieve chamber outlet duct extending from a distal (downstream) end of the sieve chamber through a wall of the plant material container; circulating the gas from the circulation device, through the outlet duct, through the plant material container, through the sieve chamber inlet duct, through the sieve chamber, through the sieve chamber outlet duct, to the plant material container, and back into the circulation device; wherein circulating the gas causes the gas to contact the plant material and the plurality of molecular sieves, wherein water within the plant material turns to water vapor and flows with the gas, wherein the water vapor contacts the molecular sieves, and wherein the molecular sieves adsorb the water vapor.

### BRIEF DESCRIPTION OF THE FIGURES

The accompanying figures, which are incorporated in and constitute a part of the specification, illustrate various example aspects, and are used merely to illustrate various example aspects. In the figures, like elements bear like reference numerals.

FIG. 1 illustrates a prior art method 100 for manufacturing a product from a frozen plant flower.

FIG. 2 illustrates a method 200 for manufacturing a product from a frozen plant flower using molecular sieves 214.

FIG. 3 illustrates a method 300 for drying a plant material using molecular sieves 322.

FIG. 4 illustrates molecular sieves 322.

FIG. 5 illustrates a system 500 for drying a plant material using molecular sieves 522.

FIG. 6A illustrates a system 600 for drying a plant material using molecular sieves.

FIG. 6B illustrates another aspect of system 600 for drying a plant material using molecular sieves.

FIG. 7A is a gas chromatogram showing the total terpene content and specific terpene content when using a traditional drying system.

FIG. 7B is a gas chromatogram showing the total terpene content and specific terpene content when using system 500.

### DETAILED DESCRIPTION

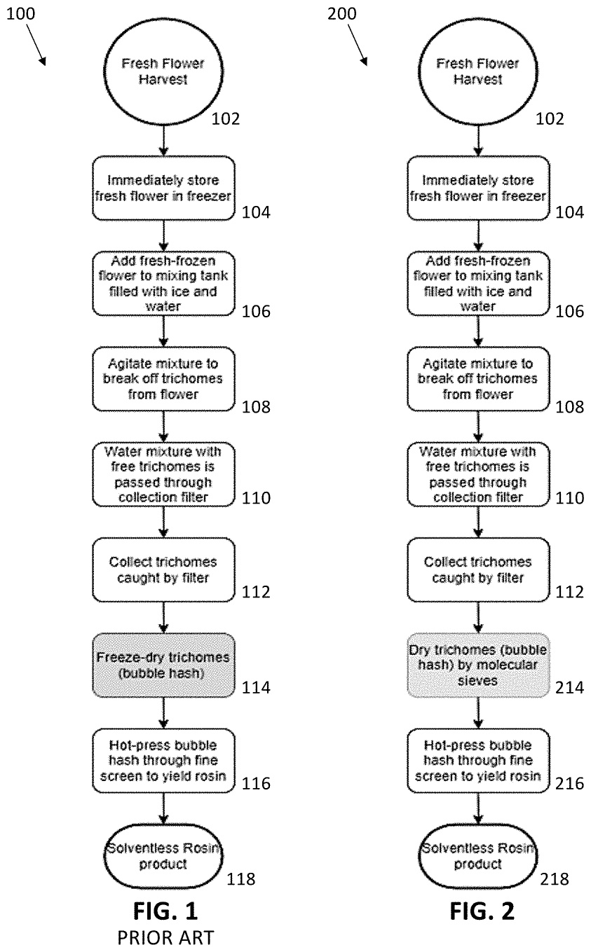

FIG. 1 illustrates a prior art method 100 for manufacturing a product from a frozen plant flower. The product may be rosin. Method 100 includes the following steps: (1) providing fresh flower harvest (step 102); (2) immediately storing the fresh flower in a freezer (step 104); (3) adding fresh-frozen flower to a mixing tank filled with ice and water (step 106); (4) agitating the mixture to break off trichomes from flower (step 108); (5) passing the water mixture with free trichomes through a collection filter (step 110); (6) collecting trichomes caught by the filter (step 112); (7) freeze-drying the trichomes (step 114); (8) hot-pressing bubble hash through a fine screen to yield rosin (step 116); and (9) forming a solventless rosin product (step 118).

FIG. 2 illustrates a method 200 for manufacturing a product from a frozen plant flower using molecular sieves 214. The product may be rosin. Method 200 includes the following steps: (1) providing fresh flower harvest (step 102); (2) immediately storing the fresh flower in a freezer (step 104); (3) adding fresh-frozen flower to a mixing tank filled with ice and water (step 106); (4) agitating the mixture to break off trichomes from flower (step 108); (5) passing the water mixture with free trichomes through a collection filter (step 110); (6) collecting trichomes caught by the filter (step 112); (7) drying the trichomes using molecular sieves (step 214); (8) hot-pressing bubble hash through a fine screen to yield rosin (step 216); and (9) forming a solventless rosin product (step 218). The fresh flower harvest may be cannabis flower. The solventless rosin product may be processed cannabis products.

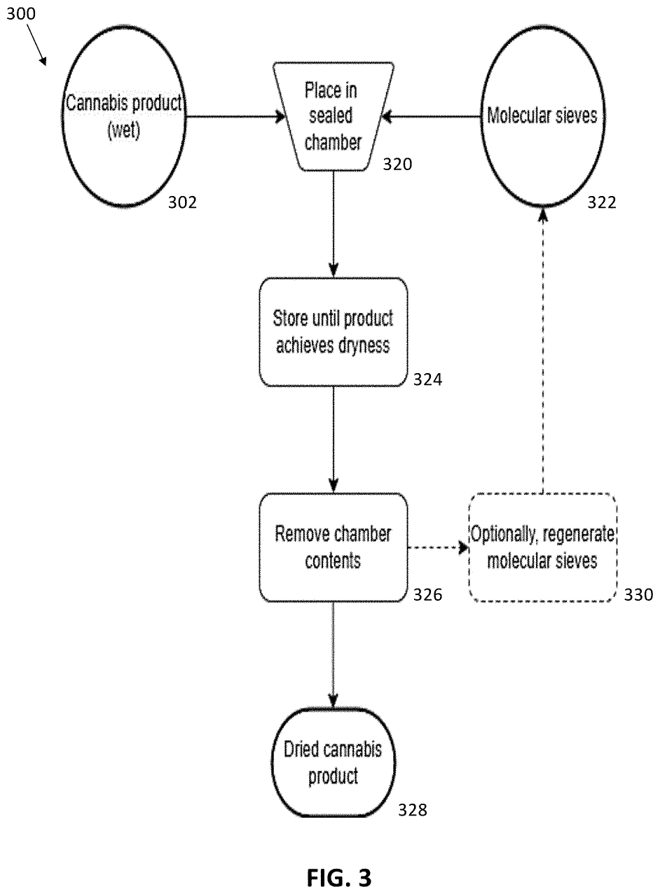

FIG. 3 illustrates a method 300 for drying a plant material using molecular sieves 322. Method 300 includes the following steps: (1) providing a wet cannabis product (that is, cannabis product that is not yet dried) (step 302); (2) placing the cannabis product into a sealed chamber (step 320); (3) exposing the interior of the sealed chamber to molecular sieves (step 322; (4) storing the product and molecular sieves in the sealed chamber until the product is dried (dried to a predetermined moisture content as desired by a user) (step 324); (5) removing the cannabis product from the sealed chamber (step 326); and (6) forming a dried cannabis product (step 328). Additionally, method 300 may include optionally regenerating the molecular sieves (step 330) for reuse in step 322. The dried cannabis product may be cannabis flower, hash, trichomes, kief, flower rosin, dry sift hash, dry sift hash rosin, bubble hash, and bubble hash rosin.

Molecular sieves may be regenerated by heating the molecular sieves to a predetermined temperature (e.g., 400° F. (204° C.) to 600° F. (316° C.)) for a predetermined amount of time. The predetermined amount of time may include any of a variety of ranges, including 6-24 hours.

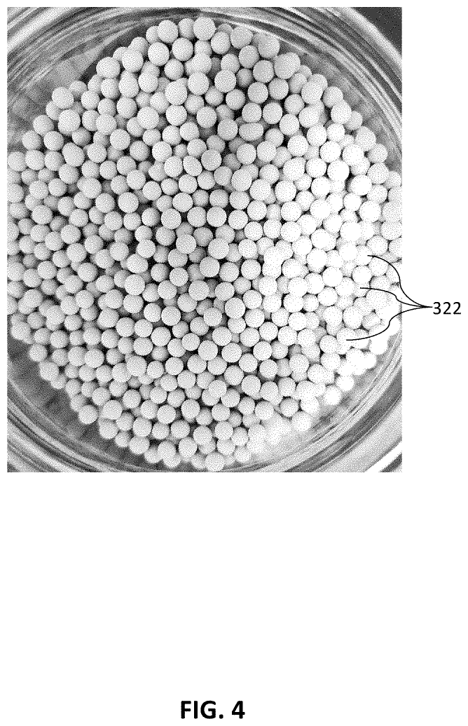

FIG. 4 illustrates molecular sieves 322. Molecular sieves 322 are materials engineered with pores of precise uniform structure and size. Molecular sieves 322 may be formed from a crystalline metal aluminosilicate. These pores may allow molecular sieves 322 to preferentially adsorb gases and liquids based upon molecular size and polarity. For example, molecular sieves 322 can be selected to adsorb liquid and/or gaseous water, while not being able to adsorb terpenes from the plant material (e.g., a cannabis flower). The term “terpene” as used herein collectively refers both to terpenes and terpenoids.

Molecular sieves 322 may include any of a variety of pore sizes, including 3 A, 4 A, 5 A, 13 X, and the like. In one aspect, molecular sieves 322 include a 4 A pore size.

Molecular sieves 322 may be substituted for any of a variety of desiccants.

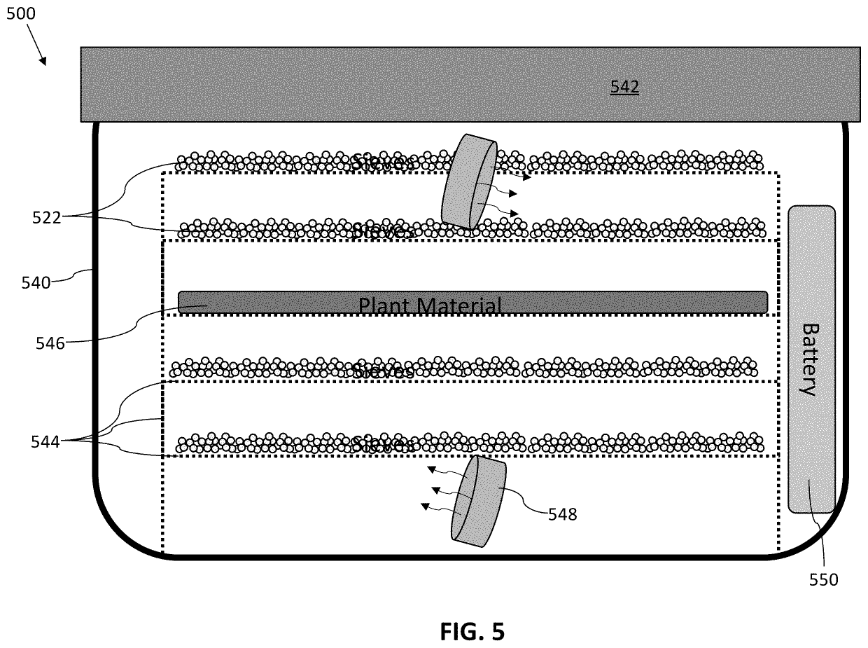

FIG. 5 illustrates a system 500 for drying a plant material using molecular sieves 522. The plant material may be any of a variety of cannabis plant materials, including for example: cannabis flower, hash, trichomes, kief, flower rosin, dry sift hash, dry sift hash rosin, bubble hash, bubble hash rosin, and the like. The plant material may be any of a variety of non-cannabis plant materials, including for example: spices, herbs, plants, hops, and the like. System 500 includes a container 540 having a lid 542. Container 540 when coupled with lid 542 may be airtight and/or watertight (that is, impervious to the air and/or water moving from the inside of the sealed container 540 to the outside, and vice versa). Container 540 when coupled with lid 542 may be substantially airtight and/or substantially watertight (that is, impervious to the air and/or water moving from the inside of the sealed container 540 to the outside, and vice versa). Within container 540, system 500 includes one or more support rack 544. Support racks 544 may include tiered platforms configured to support plant material 546 and/or molecular sieves 522. Tiered platforms may be spaced and oriented to permit air to flow over, under, and around plant material 546 and/or sieves 522.

While system 500 as illustrated includes a plurality of support racks 544, with a single support rack 544 holding plant material 546 and multiple support racks 544 holding molecular sieves 522, it is contemplated that any number (e.g., more than one) of support racks 544 can hold plant material 546, and any number of support racks 544 can support molecular sieves 522. Plant material 546 may be any of a variety of plant materials a user wishes to dry, including for example, a cannabis flower, hash, or the like.

A gas (e.g., air) and/or water vapor may be moved within the interior of container 540 by one or more circulation device 548. Circulation device 548 may be any of a variety of devices configured to move or circulate gas and/or water vapor and move gas and/or water vapor from plant material 546 to molecular sieves 522. Circulation device 548, including for example active devices such as a blower or a fan, or passive devices such as natural diffusion of water vapor or convective currents. Circulation device 548 may include a tumbling container 540 configured to move gas and/or water vapor around the interior of container 540. One or more circulation device 548 may cause air to circulate around and/or through molecular sieves 522 and plant material 546. One or more circulation device 548 may be electrically powered by a battery 550 within container 540. One or more circulation device 548 may be electrically powered by an electrical outlet via a cord extending through container 540 or lid 542 through an aperture that is otherwise sealed (e.g., a seal around the cord prevents the ingress or egress of gas and/or water vapor through the cord aperture when the cord is installed).

One or more circulation device 548 may cause a gas and/or water vapor to move through and across the surface of plant material 546, causing moisture (e.g., water) within plant material 546 to move from a liquid state to a gaseous state (e.g., water vapor). As circulation device 548 continues to cause gas and/or water vapor to move around container 540, the gas and/or water vapor may move through and across the surface of molecular sieves 522, causing molecular sieves 522 to adsorb the water vapor. This process may continue until the moisture content of plant material 546 is at or below a predetermined value. Stated differently, moisture within plant material 546 moves from the higher moisture plant material 546 to the lower humidity container 540 atmosphere, and thereafter the humidity within the container 540 atmosphere moves to molecular sieves 522 where the humidity is adsorbed.

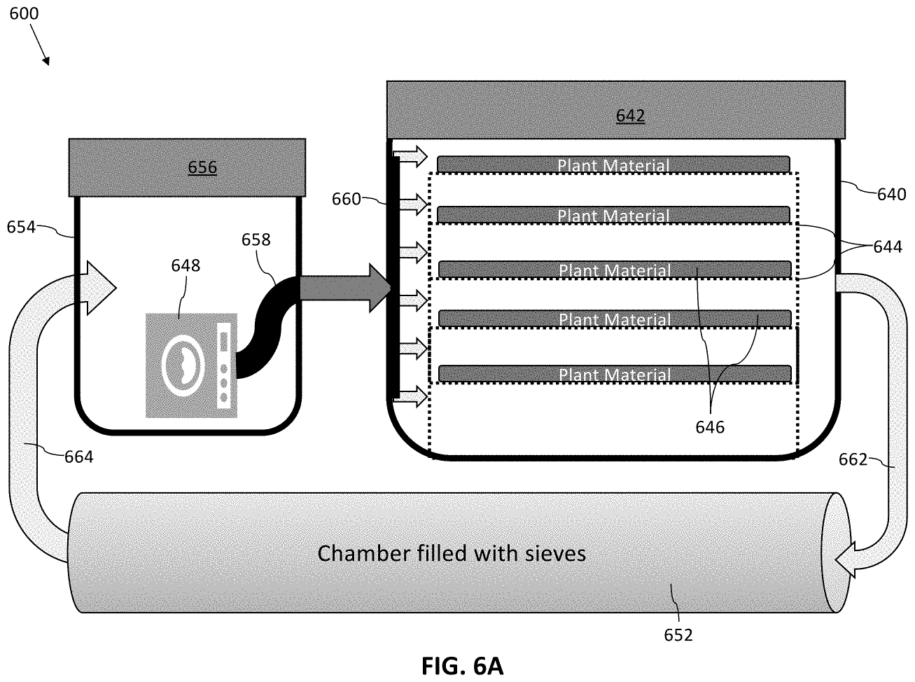

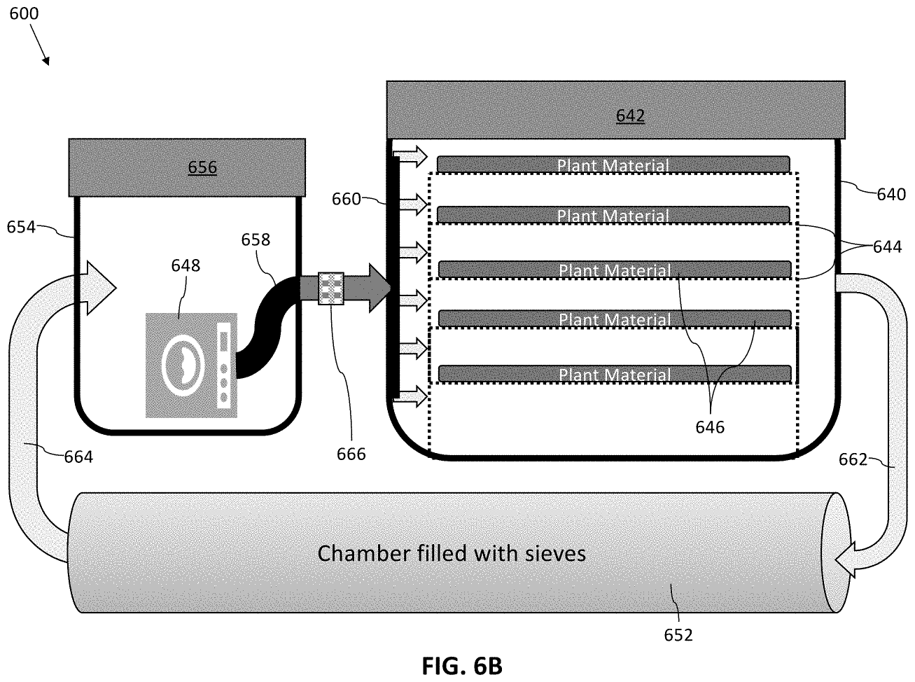

FIGS. 6A-6B illustrate a system 600 for drying a plant material using molecular sieves. The plant material may be any of a variety of cannabis plant materials, including for example: cannabis flower, hash, trichomes, kief, flower rosin, dry sift hash, dry sift hash rosin, bubble hash, bubble hash rosin, and the like. The plant material may be any of a variety of non-cannabis plant materials, including for example: spices, herbs, plants, hops, and the like.

As illustrated in FIG. 6A, system 600 includes a plant material container 640 having a lid 642. Plant material container 640 when coupled with lid 642 may be airtight and/or watertight (that is, impervious to the air and/or water moving from the inside of the sealed plant material container 640 to the outside, and vice versa). Plant material container 640 when coupled with lid 642 may be substantially airtight and/or substantially watertight (that is, impervious to the air and/or water moving from the inside of the sealed plant material container 640 to the outside, and vice versa). Within plant material container 640, system 600 includes one or more support rack 644. Support racks 644 may include tiered platforms configured to support plant material 646. Tiered platforms may be spaced and oriented to permit air to flow over, under, and around plant material 646.

System 600 includes a circulation device container 654 having a lid 656. Circulation device container 654 when coupled with lid 656 may be airtight and/or watertight (that is, impervious to the air and/or water moving from the inside of the sealed circulation device container 654 to the outside, and vice versa). Circulation device container 654 when coupled with lid 656 may be substantially airtight and/or substantially watertight (that is, impervious to the air and/or water moving from the inside of the sealed circulation device container 654 to the outside, and vice versa). Circulation device container 654 contains a circulation device 648. Circulation device 648 includes an outlet duct 658. Outlet duct 658 extends from circulation device 648, through a wall of circulation device container 654, through a wall of plant material container 640, and into a manifold 660. Outlet duct 658 extend through apertures in the walls of circulation device container 654 and plant material container 640, which are otherwise sealed (e.g., a seal around outlet duct 658 prevents the ingress or egress of gas and/or water vapor through the outlet duct 658 apertures when outlet duct 658 is installed).

Circulation device 648 forces a gas (e.g., air) and/or water vapor through outlet duct 658 and into manifold 660. Manifold 660 includes a plurality of outlets. As a result, circulation device 648 causes a gas and/or water vapor to flow through the plurality of outlets and into plant material container 640, where the gas and/or water vapor flows through and across plant material 646.

System 600 additionally includes a sieve chamber 652 containing a plurality of molecular sieves (not shown, but of the same kind as described above as molecular sieves 322 and 522). A sieve chamber inlet duct 662 extends through a wall of plant material container 640 and into sieve chamber 652 at a proximal (upstream) end of sieve chamber 652. Sieve chamber inlet duct 662 extends through an aperture in the wall of plant material container 640, which is otherwise sealed (e.g., a seal around sieve chamber inlet duct 662 prevents the ingress or egress of gas and/or water vapor through the sieve chamber inlet duct 662 aperture when sieve chamber inlet duct 662 is installed). Sieve chamber inlet duct 662 is connected to sieve chamber 652 to prevent the ingress or egress of gas and/or water vapor through the junction between sieve chamber inlet duct 662 and sieve chamber 652.

System 600 additionally includes a sieve chamber outlet duct 664 connected to sieve chamber 652 at a distal (downstream) end of sieve chamber 652. Sieve chamber outlet duct 664 is connected to sieve chamber 652 to prevent the ingress or egress of gas and/or water vapor through the junction between sieve chamber outlet duct 664 and sieve chamber 652. Sieve chamber outlet duct 664 extends through an aperture in the wall of circulation device container 654, which is otherwise sealed (e.g., a seal around sieve chamber outlet duct 664 prevents the ingress or egress of gas and/or water vapor through the sieve chamber outlet duct 664 aperture when sieve chamber outlet duct 664 is installed).

As discussed above, circulation device 648 forces a gas and/or water vapor through outlet duct 658 and into manifold 660, thus increasing the pressure of the gas and/or water vapor within the interior of plant material container 640. This increased gas and/or water vapor pressure causes the gas and/or water vapor to flow through sieve chamber inlet duct 662, through sieve chamber 652, through sieve chamber outlet duct 664, and back into circulation device container 654. Thus, circulation device 648 causes a gas and/or water vapor to circulate from circulation device container 654, through plant material container 640, into sieve chamber 652, and back into circulation device container 654, where circulation device 648 intakes the gas and/or water vapor and causes it to circulate through system 600 yet again.

Circulation device 648 causes a gas and/or water vapor to move through and across the surface of plant material 646, causing moisture (e.g., water) within plant material 646 to move from a liquid state to a gaseous state (e.g., water vapor). As circulation device 648 causes gas and/or water vapor to move into sieve chamber 652, the gas and/or water vapor moves through and across the surface of the molecular sieves (not shown), causing the molecular sieves to adsorb the water vapor. This process may continue until the moisture content of plant material 646 is at or below a predetermined value that the user desires. Stated differently, moisture within plant material 646 moves from the higher moisture plant material 646 to the lower humidity material container 640 atmosphere, and thereafter the humidity within the material container 640 atmosphere moves to the molecular sieves (not shown) within sieve chamber 652 where the humidity is adsorbed.

As illustrated in FIG. 6B, system 600 includes a particulate filter 666 oriented in outlet duct 658 between circulation device 648 and manifold 660. Particulate filter 666 may be oriented in outlet duct 658 between circulation device 648 and plant material container 640. Particulate filter 666 may be oriented in outlet duct 658 between circulation device container 654 and plant material container 640. Particulate filter 666 filters gas and/or water vapor flowing through outlet duct 658.

Sieve chamber 652 in the various arrangements of system 600 may be removable for one or more of regeneration of the molecular sieves, replacement of the molecular sieves, or replacement of sieve chamber 652. Molecular sieves may be regenerated by heating the molecular sieves to a predetermined temperature (e.g., 400° F. (204° C.) to 600° F. (316° C.)) for a predetermined amount of time. The predetermined amount of time may include any of a variety of ranges, including 6-24 hours. Thus, sieve chamber 652 may be formed from a material capable of withstanding the regeneration temperature (e.g., a metal). Sieve chamber 652 may be heated in an oven or similar heating device.

To facilitate removal for regeneration, sieve chamber 652 may be attached to sieve chamber inlet duct 662 and sieve chamber outlet duct 664 via a detachable mechanism, such as a quick disconnect connector mechanism. Alternatively, to facilitate removal for regeneration, sieve chamber inlet duct 662 and sieve chamber outlet duct 664 may be connected to circulation device container 654 and/or plant material container 640 via a detachable mechanism, such as a quick disconnect connector mechanism.

Sieve chamber 652 may include sealable ends (i.e., proximal (upstream) and distal (downstream) ends where sieve chamber inlet duct 662 and sieve chamber outlet duct 664 attach, respectively) to isolate the molecular sieves contained within sieve chamber 652 from humid ambient air after regeneration, including during storage, prepping of system 600 for use, or other periods of non-use after regeneration. Molecular sieves adsorb moisture very quickly, especially when dry (e.g., just after regeneration), so it is important to isolate dry molecular sieves from humid ambient air when not being used to dry plant material 546, 646 in systems 500, 600, to avoid water capacity loss in the molecular sieves.

All ducts described herein (outlet duct 658, sieve chamber inlet duct 662, and sieve chamber outlet duct 664) are solid wall ducts (that is, the ducts have solid walls but hollow interiors), such that gas and/or water vapor flowing through these ducts cannot leak out of the ducts into the ambient environment. Similarly, all junctions of ducts described herein are fluidically connected to the devices to which they connect (e.g., plant material container 640, circulation device container 654, and sieve chamber 652), such that gas and/or water vapor can flow through the ducts into the containers or chamber at these junctions, but not into the ambient environment.

Alternatively, sieve chamber 652 may include heating elements capable of heating sieve chamber 652 for regeneration without removing sieve chamber 652 from its operational position in system 600.

Container 540, 640 may be sized to accommodate the plant material (e.g., cannabis product) and molecular sieves (in the case of system 500) while allowing circulation device 548, 648 to circulate a gas and/or water vapor within container 540, 640. Container 540, 640 may be airtight or substantially airtight to prevent humid ambient air from entering container 540, 640 and diminishing the capacity of the molecular sieves.

Prior to use in adsorbing liquid from plant material 546, 646, molecular sieves (e.g., molecular sieves 522, not shown in FIGS. 6A-6B) must be activated by sufficiently heating the molecular sieves (optionally, under a vacuum) to remove adsorbed water. The molecular sieves can be optionally regenerated to reactivate the molecular sieves after water adsorption.

To properly dry plant material 546, 646 using systems 500, 600, plant material 546, 646 may be subjected to drying for a period of time dictated by the temperature, gas and/or water vapor circulation, quantity of plant material 546, 646, and quantity of moisture to be removed; the drying time may be between about 1 day and 5 days.

In one aspect, the ratio of molecular sieves to plant material in systems 500, 600 may be about 3:1 by mass. In another aspect, the ratio of molecular sieves to plant material in systems 500, 600 may be about 7:1 by mass. In another aspect, the ratio of molecular sieves to plant material in systems 500, 600 may be about 10:1 by mass.

Plant material 546, 646 may be dried within systems 500, 600 under ambient temperatures. Plant material 546, 646 may be dried within systems 500, 600 under less than ambient temperatures (i.e., refrigerated) to inhibit microbial growth and/or minimize degradation of terpenes.

The molecular sieves of systems 500, 600 reduce the relative humidity of the closed environment within container 540, 640, which promotes rapid drying of plant material 546, 646. Systems 500, 600 efficiently dry plant material 546, 646 without concomitant loss of terpenes.

Systems 500, 600 may use atmospheric air as the circulating gas. Alternatively, systems 500, 600 may use a gas with less oxygen content than atmospheric air to slow the oxidative degradation of terpenes. For example, atmospheric air/oxygen may be displaced with an inert gas (e.g., nitrogen) or by evacuating the oxygen from container 540, 640 to create a pressure lower than atmospheric pressure within container 540, 640. Alternatively, systems 500, 600 use a vacuum or static partial vacuum environment wherein no circulating gas is included in the system, but rather, water vapor from the plant material circulates through the system without the aid of a circulating gas.

### EXAMPLE

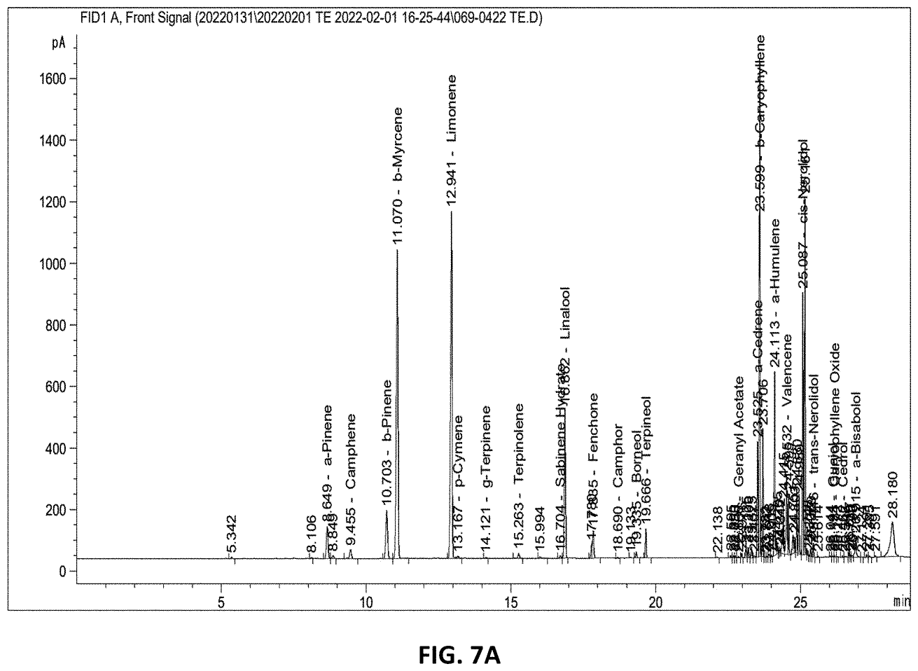

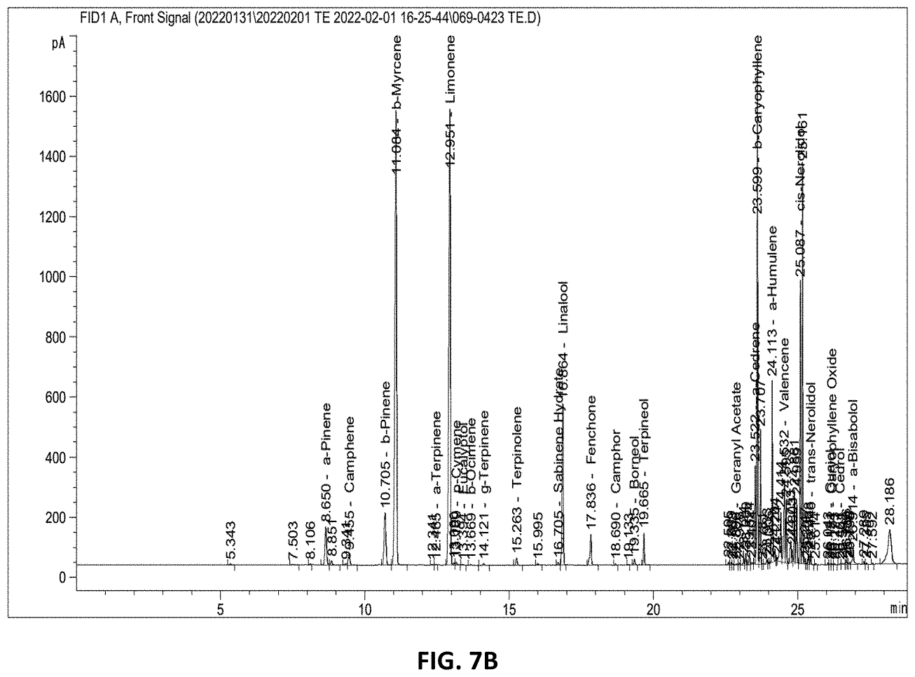

Plant material 546 was dried in a system 500 setup. The terpene content plant material 546 after drying in system 500 was measured via GC. The terpene content was compared to plant material dried using traditional methods not incorporating the use of molecular sieves. FIGS. 7A and 7B are gas chromatograms showing the total terpene content and specific terpene content when using a traditional drying system (FIG. 7A) versus using system 500 (FIG. 7B). The relative percentage increase or decrease of total terpene content and specific terpene content using system 500 versus traditional methods is contained in Table 1:

TABLE 1

| | Percentage of Terpenes Measured |
|---|---|
| | in System 500 Dried Plant |
| | Material 546 Versus Traditionally |
| Terpene Type | Dried Plant Material |
| Total Terpenes | +13% |
| Cedrene | −30% |
| a-Pinene | +14% |
| Myrcene | +31% |
| Camphene | +10% |
| Limonene | +21% |
| Fenchone | +18% |

As illustrated, dried plant material 546 retained 13% more of its total terpene content relative to plant material dried via traditional methods. This marked increase in terpene retention is important in the overall quality of the dried plant material, affecting the smell of a cannabis product, the distinction between cultivars, and/or the medical and recreational effects, which are all attributed in part to the terpene profile.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in manufacturing. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments and aspects thereof, and while the embodiments and aspects have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. A system for drying a plant material, comprising:
a substantially airtight container containing:
the plant material, and
a plurality of molecular sieves.

2. The system of claim 1, further comprising a gas.

3. The system of claim 1, further comprising a circulation device.

4. The system of claim 1, further comprising one or more support rack.

5. The system of claim 4, wherein at least one of the plant material and the plurality of molecular sieves is contained on the one or more support rack.

6. The system of claim 1, wherein the container includes a removable lid.

7. The system of claim 3, wherein the circulation device is positioned within the container to circulate the gas around an interior of the container.

8. A system for drying a plant material, comprising:
a substantially airtight plant material container containing the plant material;
a substantially airtight circulation device container containing a circulation device;
a sieve chamber containing a plurality of molecular sieves;
an outlet duct extending from the circulation device through a wall of the plant material container;
a sieve chamber inlet duct extending through a wall of the plant material container to a proximal end of the sieve chamber; and
a sieve chamber outlet duct extending from a distal end of the sieve chamber through a wall of the circulation device container.

9. The system of claim 8, further comprising one or more support rack within the plant material container, and wherein the plant material is contained on the one or more support rack.

10. The system of claim 8, further comprising a particulate filter oriented in the outlet duct between the circulation device and the plant material container.

11. The system of claim 8, wherein the plant material container includes a removable lid.

12. The system of claim 8, further comprising a manifold within the plant material container, and wherein the outlet duct is connected to the manifold inside of the plant material container.

13. The system of claim 12, further comprising a particulate filter oriented in the outlet duct between the circulation device and the manifold.

14. The system of claim 8, wherein the ratio of the molecular sieves to the plant material is 3:1 by mass.

15. The system of claim 8, wherein the sieve chamber is formed from a material capable of withstanding temperatures of 400 degrees F. to 600 degrees F.

16. The system of claim 8, wherein the sieve chamber includes heating elements capable of heating the sieve chamber to between 400 degrees F. and 600 degrees F.

17. A method for drying a plant material, comprising:
providing:
an airtight plant material container containing the plant material,
an airtight circulation device container containing a circulation device and a gas,
a sieve chamber containing a plurality of molecular sieves,
an outlet duct extending from the circulation device through a wall of the plant material container;
a sieve chamber inlet duct extending through a wall of the plant material container to a proximal end of the sieve chamber, and
a sieve chamber outlet duct extending from a distal end of the sieve chamber through a wall of the circulation device container;
circulating the gas from the circulation device, through the outlet duct, through the plant material container, through the sieve chamber inlet duct, through the sieve chamber, through the sieve chamber outlet duct, to the circulation device container, and back into the circulation device;
wherein circulating the gas causes the gas to contact the plant material and the plurality of molecular sieves,
wherein water within the plant material turns to water vapor and flows with the gas,
wherein the water vapor contacts the molecular sieves, and
wherein the molecular sieves adsorb the water vapor.

18. The method of claim 17, further comprising a manifold within the plant material container, wherein the outlet duct fluidically connects to the manifold, and wherein the circulation device causes the gas to flow from the outlet duct through the manifold and then through the plant material container.

19. The method of claim 17, wherein after drying the plant material, the sieve chamber is removed and regenerated by heating the sieve chamber and the plurality of molecular sieves to a temperature between 400 degrees F. and 600 degrees F.

20. The method of claim 17, the sieve chamber includes heating elements capable of heating the sieve chamber and the molecular sieves to between 400 degrees F. and 600 degrees F., and wherein after drying the plant material, the sieve chamber is regenerated by heating the sieve chamber and the plurality of molecular sieves to a temperature between 400 degrees F. and 600 degrees F.
